(19) United States
(12) Patent Application Publication
(10) Pub. No.: US 2022/0023801 A1
(43) Pub. Date: Jan. 27, 2022

(54) MEMBRANE ELEMENT AND PROCESS FOR MAKING THE SAME

(71) Applicant: Zhejiang Qinyuan Water Treatment S. T. Co., Ltd., Ningbo City (CN)

(72) Inventors: Xuefang CHEN, Ningbo City (CN); Xiaoping ZHANG, Ningbo City (CN)

(73) Assignee: Zhejiang Qinyuan Water Treatment S. T. Co., Ltd., Ningbo City (CN)

(21) Appl. No.: 17/311,797

(22) PCT Filed: Dec. 3, 2019
(86) PCT No.: PCT/EP2019/083412

§ 371 Date: Jun. 8, 2021

(30) Foreign Application Priority Data
Dec. 14, 2018 (CN) PCT/CN2018/121037
Jan. 30, 2019 (EP) 19154458.4

(51) Int. Cl. B01D 63/12; B01D 61/08; B01D 61/02; C02F 1/44

(52) U.S. Cl. CPC B01D 63/12; B01D 61/08; B01D 2313/13; C02F 1/44; B01D 2313/04; B01D 61/022

(57) ABSTRACT

Disclosed are a spiral wound reverse osmosis membrane element, a spiral wound reverse osmosis membrane module and a process for making the reverse osmosis membrane element.

### FIELD OF THE INVENTION

The present invention is related to a spiral wound reverse osmosis membrane element. Particularly, the present invention provides a spiral wound reverse osmosis membrane element having prolonged life and a more convenient process for making such a spiral wound reverse osmosis membrane element.

### BACKGROUND OF THE INVENTION

Pressure driven spiral wound reverse osmosis membrane elements are widely used in household water purifiers to provide purified water for consumers. The use of spiral wound reverse osmosis membranes is advantageous in that it affords very high quality of water to consumers.

Traditionally, the spiral wound reverse osmosis membrane elements are formed by winding a plurality of purification membrane groups around a central perforated treated water tube. The purification membrane group is formed by laminating a mesh-like treated water guiding member, a dual-folded reverse osmosis membrane and a mesh-like feed water guiding member inside of the dual-folded reverse osmosis membrane. A feed water flow channel is formed along the inner surfaces of the dual-folded reverse osmosis membrane and a treated water flow channel is formed between the outside surfaces of the adjacent dual-folded reverse osmosis membrane.

When such membrane element is in operation, the feed water enters the feed water flow channel from one end, either side surface or outside surface, of the spiral wound reverse osmosis membrane element. Treated water is obtained by passing the feed water through the membrane. The treated water flows along the treated water guiding member and into the central treated water tube through the water collection hole. The remaining water which as not filtered flows along the feed water guiding member and is discharged from another end of the spiral wound reverse osmosis membrane element as concentrated water. In such traditional spiral wound reverse osmosis membrane elements, the water flow channel is short and thus the velocity of the feed water is relatively slow. Therefore, the impurities would easily contaminate the membrane, resulting in shorter lifetime of the reverse osmosis membrane element.

A lot of efforts have been made to improve the lifetime of the spiral wound reverse osmosis membrane element. However, few of them may be produced in a suitable way for factory manufacture. Therefore, the present inventors have recognized that there is a need to develop a spiral wound reverse osmosis membrane element with a prolonged lifetime and easy to be made and a process for making such membrane element which is suitable for industrialization.

### SUMMARY OF THE INVENTION

In a first aspect, the present invention is directed to a spiral wound reverse osmosis membrane element (1) comprising (a) a first reverse osmosis membrane set (2) spirally wound around a first central water collection tube (3); (b) a second reverse osmosis membrane set (4) spirally wound around a second central water collection tube (5); and (c) a connector (6) connecting the first central water collection tube (3) in fluid communication with the second central water collection tube (5); wherein the outer area (221) remote from the first central tube (3) of the side surface (22) of downstream end (21) of the first reverse osmosis membrane set (2), and the outer area (421) remote from the second central tube (5) of the side surface (42) of the upstream end (41) of the second reverse osmosis membrane set (4) are both sealed; and the outside area (71) of joint (7) between the two reverse osmosis membrane sets are sealed such that the flow path of concentrated water from the downstream end (21) of the first reverse osmosis membrane set (2) is in fluid communication with the upstream end (41) of the second reverse osmosis membrane set (4).

In a second aspect, the present invention is directed to a reverse osmosis module comprising (a) a pressure vessel (8); and (b) a spiral wound reverse osmosis membrane element (1) of the present invention.

In a third aspect, the present invention is directed to a process for making the membrane element of the present invention comprising the steps of:
(i) forming three substantially parallel sealing belts (13, 14, 15) and one sealing belt (16) between a treated water guiding member (12) and a folded reverse osmosis membrane (17) to provide a reverse osmosis membrane group (18), wherein the three substantially parallel sealing belts (13, 14, 15) are along the direction of spirally winding, and the one sealing belt (16) is at one side remote from the central water collection tube;
(ii) spirally winding at least one reverse osmosis membrane group (18) around a whole central water collection tube (11);
(iii) cutting the spirally wound reverse osmosis membrane group (18) and the whole central water collection tube (11) along the middle sealing belt (14) of three substantially parallel sealing belts to provide a first reverse osmosis membrane set (2) spirally wound around a first central water collection tube (3), and a second reverse osmosis membrane set (4) spirally wound around a second central water collection tube (5);
(iv) sealing both the outer area (221) remote from the first central tube (3) of the side surface (22) of the downstream end (21) of the first reverse osmosis membrane set (2) and the outer area (421) remote from the second central tube (5) of the side surface (42) of the upstream end (41) of the second reverse osmosis membrane set (4);
(v) connecting the downstream end (31) of the first central water collection tube (3) in fluid communication with the upstream end (51) of the second central water collection tube (5) by a connector (6); and
(vi) sealing the outer area of the joint (7) between the two sets of reverse osmosis membranes (2, 4) such that the concentrated water from the downstream end (21) of the first reverse osmosis membrane set (2) is capable of flowing into the upstream end (41) of the second reverse osmosis membrane set (4).

These and other aspects of the present invention will more readily become apparent upon considering the detailed description and examples which follow.

### BRIEF DESCRIPTION OF THE FIGURES

FIG. 1 is a front view of a preferred embodiment of the spiral wound reverse osmosis membrane element according to the present invention.

FIG. 2 is a cross-sectional view of the spiral wound reverse osmosis membrane element of FIG. 1.

FIG. 3 is an exploded perspective view of the spiral wound reverse osmosis membrane element of FIG. 1.

FIG. 4 is a front view of the side surface of the downstream end of the first reverse osmosis membrane set with downstream end of the first central water collection tube, or the side surface of the upstream end of the second reverse osmosis membrane set with downstream end of the first central water collection tube as shown in FIG. 3.

FIG. 5 is an elevation view of the connector as shown in FIG. 3.

FIG. 6 is a cross-sectional view of a preferred embodiment of the spiral wound reverse osmosis membrane module according to the present invention.

FIG. 7 is an elevation view of a treated water guiding member attached to a whole central water collection tube after formation of four glue belts.

FIG. 8 is an elevation view after a dual-folded reverse osmosis membrane putting onto the treated water guiding member of FIG. 7 to provide a spiral wound reverse osmosis membrane group.

FIG. 9 is a front view of reverse osmosis membrane group(s) of FIG. 8 spiral wound around a whole central water collection tube.

FIG. 10 is a front view of dissected reverse osmosis membrane group(s) spiral wound around a whole central water collection tube.

### DESCRIPTION OF THE SYMBOLS

1 Spiral wound reverse osmosis membrane element
2 First reverse osmosis membrane set
21 Downstream end of 2
22 Side surface of 21
23 Upstream end of 2
24 Outside surface of 2
3 First central water collection tube
31 Downstream end of 3
32 Upstream end of 3
4 Second reverse osmosis membrane set
41 Upstream end of 4
42 Side surface of 41
43 Downstream end of 4
44 Outside circumferential surface of 4
5 Second central water collection tube
51 Upstream end of 5
52 Downstream end of 5
6 Connector
61 Communication tube
62 Annular portion
63 Ribs
7 Joint
71 Outside surface of 7
8 Pressure vessel
81 Tubular container
82 Cap
83 Feed water inlet
84 Treated water outlet
85 Concentrated water outlet
11 Whole central water collection tube
12 Treated water guiding member
13, 14, 15, 16 Glue belts
17 Dual-folded reverse osmosis membrane
18 Reverse osmosis membrane group(s) spirally wound the whole central water collection tube

### DETAILED DESCRIPTION OF THE INVENTION

Except in the examples, or where otherwise explicitly indicated, all numbers in this description indicating amounts of material or conditions of reaction, physical properties of materials and/or use may optionally be understood as modified by the word “about”.

It should be noted that in specifying any range of values, any particular upper value can be associated with any particular lower value.

For the avoidance of doubt, the word “comprising” is intended to mean “including” but not necessarily “consisting of” or “composed of”. In other words, the listed steps or options need not be exhaustive.

The disclosure of the invention as found herein is to be considered to cover all embodiments as found in the claims as being multiply dependent upon each other irrespective of the fact that claims may be found without multiple dependency or redundancy.

Where a feature is disclosed with respect to a particular aspect of the invention (for example a product of the invention), such disclosure is also to be considered to apply to any other aspect of the invention (for example a process of the invention) mutatis mutandis.

Preferably, the side surface of the upstream end of the first reverse osmosis membrane set, and the side surface of the downstream end of the second set of reverse membrane are sealed, preferably by means of glue. Preferably, the longitudinal length of the first reverse osmosis membrane set is larger that of the second reverse osmosis membrane. To provide an optimal lifetime of the reverse osmosis element, the ratio of longitudinal length of the first reverse osmosis membrane set to the longitudinal length of the second reverse osmosis membrane is preferably 1:3 to 5:1, more preferably 1:1 to 4:1, even more preferably 1.2:1 to 4:1 and most preferably from 1.5:1 to 3:1. Preferably, the feed water flows into the first reverse osmosis membrane set through the outside surface of the first reverse osmosis membrane set. The feed water flows through the first reverse osmosis membrane set and then to the second reverse osmosis membrane set. The outside surface refers to the curved lateral surface of the reverse osmosis membrane set.

To provide a higher velocity of the feed water, preferably at least part of the outside surface of the first reverse osmosis membrane set and at least part of the outside surface of the second reverse osmosis membrane set are not wrapped by plastic strips. Alternatively, the outside surfaces of the first and second sets of reverse osmosis membrane are preferably wrapped by perforated plastic strips. In such way, the feed water may flow into the outside surface of the first reverse osmosis membrane set and the concentrated water may flow out from the outside surface of the second reverse osmosis membrane set.

Preferably, the sealed outer areas of the side surfaces of downstream end of the first reverse osmosis membrane set and of the upstream end of the second reverse osmosis membrane set are annular. Preferably, the area of the sealed portion to that of the unsealed portion in the side surface is 1:1 to 15:1, preferably 2:1 to 8:1.

For sake of improved durability for the connected central water collection pipes, a connector is used. Preferably, the connector comprises a communication tube engaged with the two central water collection tubes, preferably by means of friction fastening. Preferably, the outer diameter of the communication tube is substantially same as the inner diameter of the central water collection tube. In such way, the communication tube may be inserted into the inner surface of the two central water collection tubes to ensure these two central water collection tubes are water-tightly connected in fluid communication with each other.

Preferably, the connector comprises an annular portion surrounding the communication tube and a plurality of ribs coupling the communication tube and the annular portion together. The concentrated water may flow through the spaces between the ribs.

Preferably, the annular portion is surrounding the longitudinal center of the communication tube. Preferably, the connector comprises 3 to 10 of ribs coupling the communication tube and the annular portion. Preferably, the thickness of the annual portion is substantially same as the thickness of the rib. Preferably, the thickness of the joint is substantially same as the thickness of the annular portion. Preferably, the radius of the annular portion is substantially same as the radius of the inner area of the side surfaces of downstream end of the first reverse osmosis membrane set and of the upstream end of the second reverse osmosis membrane set.

Preferably, the joint between the two sets of reverse osmosis membrane is wrapped and sealed by plastic strips at the outside surface. Thus, the concentrated water is capable of flowing out from the inner area of the side surface of the downstream end of the first set of reverse osmosis membrane and flowing into the second set of reverse osmosis membrane through the inner area of the side surface of the upstream end of the second set of reverse osmosis membrane.

Preferably, the pressure vessel comprises a tubular container and a cap engaged with the tubular container, preferably at the upstream end of the pressure vessel. Preferably, the cap is engaged with the tubular container by means of thread. Preferably, the pressure vessel comprises a feed water inlet at the upstream end of the pressure vessel, a treated water outlet and a concentrated water outlet at the downstream end of the pressure vessel. Preferably the feed water inlet is provided at the cap, more preferably at the middle of cap.

Preferably, the downstream end of the second central water collection tube are water tightly connected with the treated water outlet such that the treated water may be discharged from the treated water outlet. Preferably, the upstream end of the first central water collection tube are sealed.

Preferably, the reverse osmosis module comprises a brine seal between the reverse osmosis membrane element and the inner wall of the vessel to prevent the feed water flow from bypassing element, wherein the brine seal is provided around the joint between the two sets of reverse osmosis membranes.

The present invention also provides a process for making the spiral wound reverse osmosis membrane element. Preferably, the step (i) is replaced by conducting step (a) to (d):
(a) attaching one side of a treated water flow guiding member to a central water collection tube;
(b) coating three substantially parallel glue belts onto the treated water flow guiding member along the direction of spirally winding and one glue belts at one side remote from the central water collection tube;
(c) putting the dual-folding reverse osmosis membrane onto the treated water flow guiding member with the folded side toward the central water collection tube to form four sealing belts to provide a reverse osmosis membrane group, wherein the feed water flow guiding member is provided inside onto the treated water flow guiding membrane; and
(d) optionally repeating the step of providing a treated water flow guiding member, (b), and (c).

Preferably, in step (iv) the sealing of the outer areas is conducted by means of glue. Preferably, in step (vi), the sealing of outer area of the joint between the two sets of reverse osmosis membrane is conducted by wrapping a plastic strip at the outside surface of the joint.

Preferably, a step (e) of drying the glue is conducted before step (v), preferably by means of naturally drying.

In some embodiments, a step of wrapping the spiral wound reverse osmosis membrane by plastic strips at the outside surface is preferably conducted before step (iii) and a step of removing the plastic strips wrapped at the outside surfaces of the first and second reverse osmosis membrane sets. In other embodiments, a step of wrapping the spiral wound reverse osmosis membrane by perforated plastic strips at the outside surface is preferably conducted.

### EXAMPLES

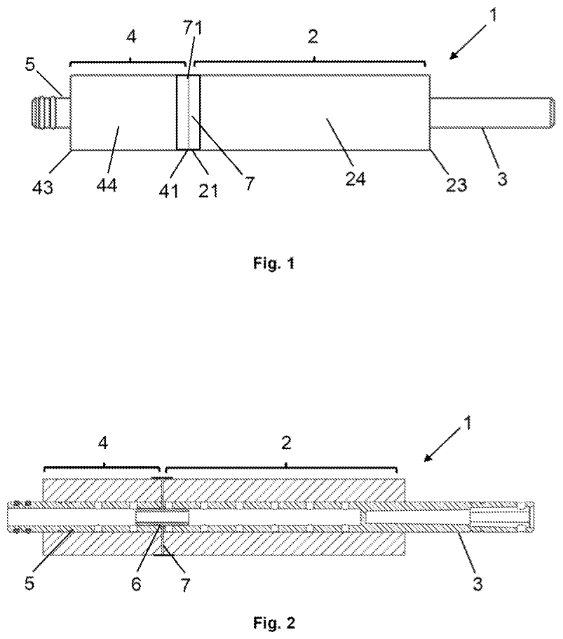

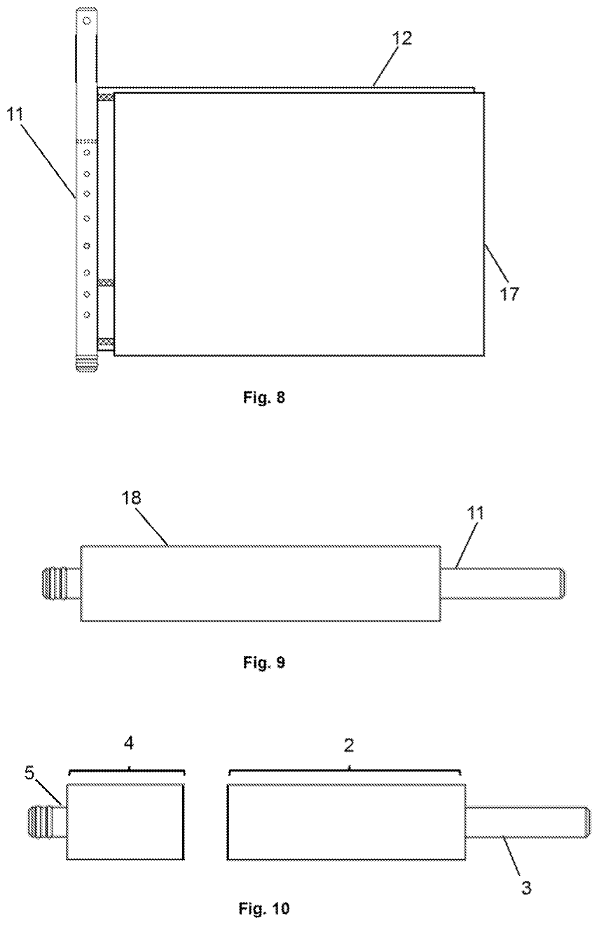

The following example is provided in FIGS. 1 to 10 to facilitate an understanding of the invention. The example is not intended to limit the scope of the claims.

As illustrated in FIG. 1, the spiral wound reverse osmosis membrane element 1 has a first reverse osmosis membrane set 2 spirally wound around a first central water collection tube 3 and a second reverse osmosis membrane set 4 spirally wound around a second central water collection tube 5. The joint 7 between the downstream end 21 of the first reverse osmosis membrane set 2 and the upstream end 41 of the second reverse osmosis membrane set 4 is wrapped by plastic strips at the outside surface thereby closed and sealed at the outside surface 71 of the joint 7. The side surfaces of the upstream end 23 of the first reverse osmosis membrane set 2 and the downstream end 43 of the second reverse osmosis membrane set 4 are sealed by glue.

Each reverse osmosis membrane set comprises at least one folded reverse osmosis membrane. A feed water flow channel is formed between the inner surfaces of the folded reverse osmosis membrane. A mesh-like feed water flow guiding member is placed into the feed water flow channel. A treated water flow channel is formed between outside surfaces of the adjacent folded reverse membranes. A mesh-like treat water flow guiding member is placed into the treated water flow channel. The treated water flow channel is glued at the two sides along the direction of spirally winding and one side remote from the central treated tube such that the treated water flow channel has one opening toward the central water collection tube. The central water collection tube has a plurality of perforated holes to gather the treated water.

As illustrated in FIG. 2, a connector 6 attaches the first and central water collection tube (3, 5) together. The outer radius of the communication tube of the connecter fits the inner radius of the central water collection tubes such that the first water collection tube 3 is in fluid communication with the second central water collection tube 5 without leakage. The the joint 7 between the two sets of reverse osmosis membrane are wrapped and sealed by plastic strips at the outside surface 71.

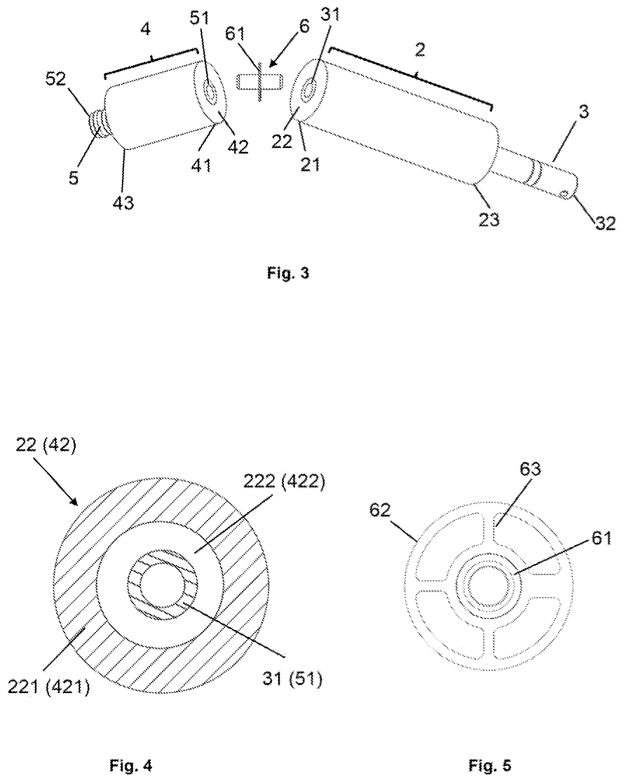

FIG. 3 shows the exploded view of the spiral wound reverse osmosis membrane element after removing the plastic strips outside of the joint and FIG. 4 shows the front view of side surface of downstream end of the first reverse osmosis membrane set (or side surface of upstream end of the second reverse osmosis membrane set as they are substantially same). The outer annular areas (221, 421) remote from the central tubes (3, 5) of the side surfaces (22, 42) of downstream end 21 of the first reverse osmosis membrane set 2 and the upstream end 41 of the second reverse osmosis membrane set 4 are sealed by glue. The inner annular areas (222, 422) close to the central tubes (3, 5) are not sealed. Thus, the concentrated water may flow out from the inner annular area 222 of the side surface 22 of the downstream end 21 of the first reverse osmosis membrane set 2 and into the inner annular area 422 of the side surface 42 of the upstream end 41 of the second reverse osmosis membrane set 4.

As illustrated FIG. 5, the connector 6 comprises a communication tube 61 fitted into the inner sides of the two central water collection tubes, an annular portion 62 surrounding the central portion of communication tube 61 and four ribs 63 coupling the communication tube and the annular portion together. Thus, the concentrated water from the downstream end of the first reverse osmosis membrane set is capable of flowing into the upstream end of the second reverse osmosis membrane set through the spaces among the ribs 63. The connector 6 also improves the mechanical durability of connected central water collection tubes.

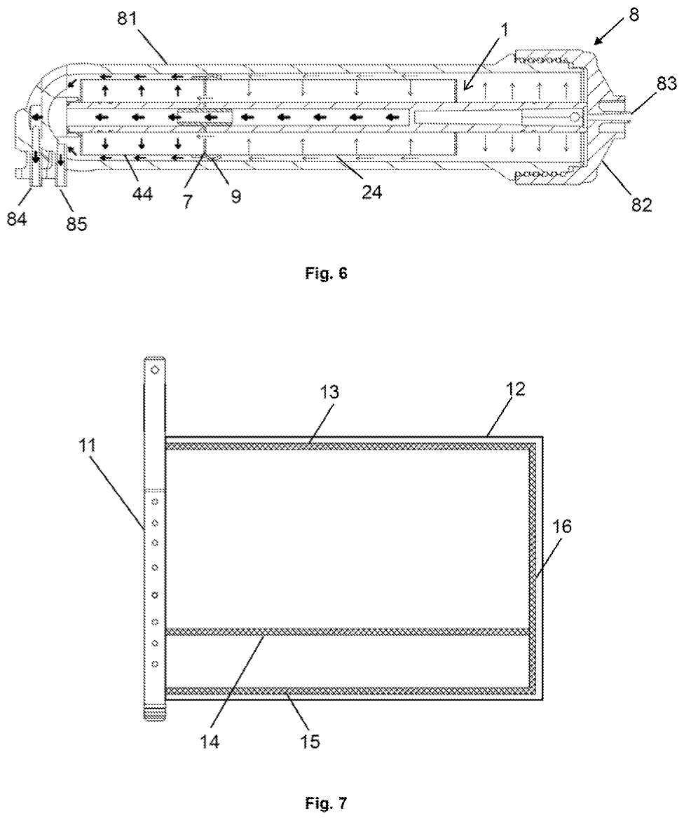

As illustrated in FIG. 6, the reverse osmosis module comprising a pressure vessel 8 and a spiral wound reverse osmosis membrane element 1 according to the present invention. The pressure vessel 8 comprising a tubular container 81 and a cap 82 attached the upstream end of the tubular container. The cap 82 contains a feed water inlet 83 in the middle of the cap 82. The tubular container 81 has a treated water outlet 84 and concentrated outlet 85 at the downstream end of the tubular container 81. The spiral wound reverse osmosis membrane element 1 is placed inside of the tubular container 81. The side surfaces of the upstream end 23 of the first reverse osmosis membrane set 2 and the downstream end 43 of the second reverse osmosis membrane set 4 are sealed by means of glue. The upstream end 31 of the first central water collection tube 3 are sealed by means of glue. The downstream end 51 of the second central water collection tube 5 is connected impermeably with the treated water outlet 84. A brine seal 9 is provided around the joint 7 between the two sets of reverse osmosis membrane, and between the reverse osmosis membrane element 1 and the inner wall of the tubular contain 81 to prevent the feed water flow from bypassing the spiral wound reverse osmosis membrane element 1.

When the reverse osmosis module operates, the feed water is pumped inside of the pressure vessel 8 through the feed water inlet 83 and pushed inside of the first reverse osmosis membrane set 2 through the outside surface 24 of the first reverse osmosis membrane set 2. Thus, the feed water is filtered by the first reverse osmosis membrane set 2 to generate treated water and concentrated water. The treated water flows inside of the first central water collection tube 3. The concentrated water flows out from the inner annular area 222 of the side surface 22 of the downstream end 21 of the first reverse osmosis membrane set 2 and into the inner annular area 422 of the side surface 42 of the upstream end 41 of the second reverse osmosis membrane set 4. The concentrated water is filtered again by the second reverse osmosis membrane set 4 and flows out from the outside surface 44 of the second reverse osmosis membrane set 4. The treated water is discharged through the treated water outlet 84 and the concentrated are discharged through the concentrated water outlet 85.

The water flow path is significantly increased and provides a lot of benefits including increase of the water flow velocity and lifetime improvement of the spiral wound reverse osmosis membrane element.

FIGS. 7 to 10 illustrate how the spiral wound reverse osmosis membrane element is prepared. The first side of a mesh-like rectangular treated water flow guiding member 12 was attached to a whole central water collection tube 11. Then, first two substantially parallel glue belts (13, 15) were formed close to the second and third sides. The third glue belt 14 was formed substantially parallel to the first two glue belts (13, 15). The third glue belt 14 is provided at the two third part of the treated water flowing guiding member as shown in FIG. 7. A forth glue belt 16 was formed close to side remote from the central water collection tube.

Then, a reverse osmosis membrane was folded dually and a mesh-like rectangular feed water flow guiding member inside of the folded reverse osmosis membrane. The dual folded reverse osmosis membrane 17 was placed onto the treated water flow guiding member. The water flow guiding member 12 and the folded reverse osmosis membrane 17 were adhered to each other by the glue belts to provide a reverse osmosis membrane group 18. The steps of providing treated water flow guiding member, forming glue belts and adhering the folded reverse osmosis membrane with feed water flow guiding member inside was repeated again and a second reverse osmosis membrane group are formed onto the second reverse osmosis membrane group.

The reverse osmosis membrane groups 18 are spirally wound around the whole central water collection tube 11 as shown in FIG. 9. The spirally wound reverse osmosis membrane groups was cut along the third blue belt to form the first reverse osmosis membrane set 2 spirally wound around the first central water collection tube 3, and the second reverse osmosis membrane set 4 spirally wound around a second central water collection tube 5 as shown in FIG. 10.

Then, the outer annular areas (221, 421) of the side surfaces (22, 42) of downstream end 21 of the first reverse osmosis membrane set 2 and the upstream end 41 of the second reverse osmosis membrane set 4 are sealed by means of glue as shown in FIG. 4. After the glue hardens by drying naturally, the two ends of the communication tube of the connecter were inserted into the downstream end of the first central water collection tube and the upstream end of the second central water collection tube separately. A plastic tape was spirally wound around the outside surface 71 of the joint 7 between the first and second reverse osmosis membrane sets. Thus, the concentrated water from the downstream end 22 of the first reverse osmosis membrane set 2 is capable of flowing into the upstream end 42 of the second reverse osmosis membrane set 2.

The side surfaces of the upstream end 23 of the first reverse osmosis membrane set 2 and the downstream end 43 of the second reverse osmosis membrane set 4 are fully sealed by means of glue. The upstream end of the first central water collection tube 3 was also sealed by means of glue. An annular sealing member 9 is disposed outside the plastic strip and around the joint 7. The spiral wound reverse osmosis membrane element 1 was then mounted into a pressure vessel 8 to produce the reverse osmosis module.

A comparison test was conducted between a traditional reverse osmosis module A and a reverse osmosis module as prepared in this example (named as E) using the same feed water. A and E are substantially same except that the A has integrated reverse osmosis membrane spirally wound around a whole central treated water collection pipe. When the rate of flow of the treated water is below 150 ml/min, it is considered the reverse osmosis module needs to be replaced. The lifetime of the reverse osmosis module is the total volume of generated water when the rate of flow of the treated water is no less than 150 ml/min. For module A, the initial rate of flow of the treated water was 240 ml/min and dropped to 150 ml/min after it generated treated water with volume of 750 L. In contrast, Module E had an initial rate of flow of the treated water of 350 ml/min and generated 1380 L of treated water when the rate of flow of the treated water dropped to 150 ml/min. Therefore, it was demonstrated that the lifetime of the reverse osmosis membrane element of was significantly improved.

The process of the present invention only needs one step of reverses osmosis membrane group spirally winding to achieve a longer water flow channel. In addition, the glue coating is easily to be operated on dissected side surfaces. Therefore, this process is suitable for factory manufacture which has high efficiency and improved reliability.

1-12. (canceled)

13. A reverse osmosis module comprising:
a. a pressure vessel (8);
b. pressure vessel (8) comprising a tubular container (81) and a cap (82) attached the upstream end of the tubular container, the cap (82) contains a feed water inlet (83) in the middle of the cap (82);
c. tubular container (81) has a treated water outlet (84) and concentrated outlet (85) at the downstream end of the tubular container (81);
d. spiral wound reverse osmosis membrane element (1) placed inside of the tubular container (81);
the reverse osmosis membrane element (1) comprising:
(i) a first reverse osmosis membrane set (2) spirally wound around a first central water collection tube (3);
(ii) a second reverse osmosis membrane set (4) spirally wound around a second central water collection tube (5); and
(iii) a connector (6) connecting the first central water collection tube (3) in fluid communication with the second central water collection tube (5);
wherein the outer area (221) remote from the first central tube (3) of the side surface (22) of downstream end (21) of the first reverse osmosis membrane set (2), and the outer area (421) remote from the second central tube (5) of the side surface (42) of the upstream end (41) of the second reverse osmosis membrane set (4) are both sealed; and the outer area of joint (7) between the two reverse osmosis membrane sets are sealed such that the flow path of concentrated water from the downstream end (21) of the first reverse osmosis membrane set (2) is in fluid communication with the upstream end (41) of the second reverse osmosis membrane set (4);
and wherein side surface of upstream end (23) of the first reverse osmosis membrane set (2) and side surface of downstream end (43) of second reverse osmosis membrane set (4) are fully sealed by means of glue and upstream end (32) of the first central water collection tube (3) are sealed by means of glue; and downstream end (52) of the second central water collection tube (5) is connected impermeably with treated water outlet (84);
e. brine seal (9) is provided around the joint (7) between the two sets of reverse osmosis membrane, and between the reverse osmosis membrane element (1) and the inner wall of the tubular contain (81) to prevent the feed water flow from bypassing the spiral wound reverse osmosis membrane element (1);
wherein the reverse osmosis module being arranged such that when the reverse osmosis module operates, the feed water is pumped inside of the pressure vessel (8) through the feed water inlet (83) and pushed inside of the first reverse osmosis membrane set (2) through the outside surface (24) of the first reverse osmosis membrane set (2), the feed water is filtered by the first reverse osmosis membrane set (2) to generate treated water and concentrated water and the treated water flows inside of the first central water collection tube (3) while the concentrated water flows out from the inner annular area (222) of the side surface (22) of the downstream end (21) of the first reverse osmosis membrane set (2) and into the inner annular area (422) of the side surface (42) of the upstream end (41) of the second reverse osmosis membrane set (4); and
wherein the concentrated water is filtered again by the second reverse osmosis membrane set (4) and flows out from the outside surface (44) of the second reverse osmosis membrane set (4) and the treated water is discharged through the treated water outlet (84) and the concentrated are discharged through the concentrated water outlet (85).

14. A reverse osmosis module according to claim 13, wherein
the connector (6) comprises a communication tube (61) fitted into the inner sides of the two central water collection tubes.

15. The reverse osmosis module according to claim 13 wherein
the connector (6) comprises an annular portion (62) surrounding the communication tube (61) and a plurality of ribs (63) coupling the communication tube and the annular portion together.

16. The reverse osmosis module according to claim 13 wherein the first reverse osmosis membrane set (2) is longitudinally longer than the second reverse osmosis membrane set (4), preferably the ratio of the longitudinal length of the first reverse osmosis membrane set (2) to the longitudinal length of the second reverse osmosis membrane set (4) is 1.5:1 to 3:1.

17. The reverse osmosis module according to claim 13 wherein the joint (7) between the two sets of reverse osmosis membrane are wrapped and sealed by plastic strips at the outside surface (71) of the joint.

18. A process for making the membrane element according to claim 13 comprising the steps of:
(i) forming three substantially parallel sealing belts (13, 14, 15) and one sealing belt (16) between a treated water guiding member (12) and a folded reverse osmosis membrane (17) to provide a reverse osmosis membrane group (18), wherein the three substantially parallel sealing belts (13, 14, 15) are along the direction of spirally winding, and the one sealing belt (16) is at one side remote from the central water collection tube;
(ii) spirally winding at least one reverse osmosis membrane group (18) around a whole central water collection tube (11);
(iii) cutting the spirally wound reverse osmosis membrane group (18) and the whole central water collection tube (11) along the middle sealing belt (14) of three substantially parallel sealing belts to provide a first reverse osmosis membrane set (2) spirally wound around a first central water collection tube (3), and a second reverse osmosis membrane set (4) spirally wound around a second central water collection tube (5);
(iv) sealing both the outer area (221) remote from the first central tube (3) of the side surface (22) of the downstream end (21) of the first reverse osmosis membrane set (2) and the outer area (421) remote from the second central tube (5) of the side surface (42) of the upstream end (41) of the second reverse osmosis membrane set (4);
(v) connecting the downstream end (31) of the first central water collection tube (3) in fluid communication with the upstream end (51) of the second central water collection tube (5) by a connector (6);
(vi) fully sealing the side surface of upstream end (23) of the first reverse osmosis membrane set (2) and the side surface of downstream end (43) of second reverse osmosis membrane set (4); and
(vii) sealing the outer area of the joint (7) between the two sets of reverse osmosis membranes (2, 4) such that the concentrated water from the downstream end (21) of the first reverse osmosis membrane set (2) is capable of flowing into the upstream end (41) of the second reverse osmosis membrane set (4).

19. The process according to claim 18 wherein the sealing belts are formed by glue.

20. The process according to claim 18 wherein the sealing the outer area of the joint is conducted by wrapping a plastic strip at the outside surface (71) of the joint (7).
